(19) United States
(12) Patent Application Publication
(10) Pub. No.: US 2019/0102050 A1
(43) Pub. Date: Apr. 4, 2019

(54) DISPLAY CONTROL DEVICE

(71) Applicant: TOYOTA JIDOSHA KABUSHIKI KAISHA, Toyota-shi (JP)

(72) Inventors: Shoji KAKINUMA, Okazaki-shi (JP); Hirotake SANO, Nagakute-shi (JP); Tatsuya TANIZAWA, Nisshin-shi (JP); Akihiro UEDA, Nisshin-shi (JP); Koshi ITO, Okazaki-shi (JP)

(73) Assignee: TOYOTA JIDOSHA KABUSHIKI KAISHA, Toyota-shi (JP)

(21) Appl. No.: 16/058,406

(22) Filed: Aug. 8, 2018

(30) Foreign Application Priority Data
Sep. 29, 2017 (JP) 2017-191733

(51) Int. Cl. G06F 3/0482; G06F 3/0481

(52) U.S. Cl. CPC G06F 3/0482; G06F 3/0488; G06F 3/04812

(57) ABSTRACT

A display control device includes: a receiving unit configured to receive operation information input into a touch input portion placed at a position distanced from a display portion; and a processing unit configured to control display of the display portion according to the operation information received by the receiving unit. The processing unit is configured to display a plurality of first options belonging to a first hierarchy, a plurality of second options belonging to a second hierarchy as a hierarchy subsequent to the first hierarchy, and a cursor placed at one of the plurality of second options on the display portion when the receiving unit receives a selection operation in a state where the cursor is placed at one of the plurality of first options.

### INCORPORATION BY REFERENCE

The disclosure of Japanese Patent Application No. 2017-191733 filed on Sep. 29, 2017 including the specification, drawings and abstract is incorporated herein by reference in its entirety.

### BACKGROUND

### 1. Technical Field

The disclosure relates to a display control device.

### 2. Description of Related Art

Japanese Unexamined Patent Application Publication No. 2012-022393 (JP 2012-022393 A) describes a vehicle display device for displaying a plurality of hierarchical menus. The vehicle display device includes a display on which menus in a first hierarchy that are arranged in the lateral direction and menus in a second hierarchy that are arranged in the vertical direction can be displayed, and a cross key operable in the lateral direction and in the vertical direction. When the cross key is operated laterally so that one of the menus in the first hierarchy is selected, menus in the second hierarchy corresponding to the selected menu in the first hierarchy are displayed while the menus in the first hierarchy are displayed.

### SUMMARY

In the technique of JP 2012-022393 A, after a user selects a menu in the first hierarchy to display menus in its corresponding second hierarchy, it is necessary to perform an operation to move a cursor to the menus in the second hierarchy from the menu in the first hierarchy.

The disclosure provides a technique to simplify an operation for selection from options with a hierarchical structure.

An aspect of the disclosure provides a display control device including: a receiving unit configured to receive operation information input into a touch input portion placed at a position distanced from a display portion; and a processing unit configured to control display of the display portion according to the operation information received by the receiving unit. The processing unit is configured to display a plurality of first options belonging to a first hierarchy, a plurality of second options belonging to a second hierarchy as a hierarchy subsequent to the first hierarchy, and a cursor placed at one of the plurality of second options on the display portion when the receiving unit receives a selection operation in a state where the cursor is placed at one of the plurality of first options.

In the aspect, when a first option is selected, the cursor is automatically moved to a second option in the subsequent hierarchy, so that it is possible to reduce an operation for a user to move the cursor from the first option to the second option.

In the above aspect, the processing unit may be configured to place the cursor at a second option that is not placed in an end on the display portion, from among the plurality of second options displayed in line on the display portion, when the display of the display portion is changed from a state where the cursor is placed at the one of the plurality of first options to a state where the cursor is placed at the one of the plurality of second options.

According to the above configuration, the operation direction is not limited to one direction, and therefore, the cursor can be easily moved to other second options.

In the above aspect, the processing unit may be configured to display the cursor at a previously selected first option when the receiving unit receives an operation to return to the first hierarchy in a state where the cursor is placed at any one of the plurality of second options.

Hereby, when the operation to return to the first hierarchy is performed, the cursor is placed at the previously selected first option, thereby making it possible to reduce an operation to move the cursor.

In the above aspect, the processing unit may be configured to place the cursor at a second option placed at a second top position on the display portion, from among the plurality of second options displayed in line on the display portion, when the display of the display portion is changed from the state where the cursor is placed at the one of the plurality of first options to the state where the cursor is placed at any of the plurality of second options.

In the above aspect, the processing unit may be configured to display the plurality of second options and a plurality of third options belonging to a third hierarchy as a hierarchy subsequent to the second hierarchy, and the cursor placed at one of the plurality of third options on the display portion when the receiving unit receives a selection operation in a state where the cursor is placed at one of the plurality of second options.

In the above aspect, the processing unit may be configured to display, on the display portion, the plurality of third options and a plurality of fourth options belonging to a fourth hierarchy as a hierarchy subsequent to the third hierarchy, and the cursor placed at one of the plurality of fourth options in a state where the plurality of third options is displayed with a reduced width as compared to a width of the plurality of third options before the plurality of fourth options are displayed when the receiving unit receives a selection operation in a state where the cursor is placed at one of the plurality of third options.

In the above aspect, the processing unit may be configured to display a first option selected from among the plurality of the first options with a pixel value different from the other first options, while the plurality of second options are displayed on the di splay portion.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view to describe a touch input portion and a display portion provided in a vehicle;

FIG. 2 is a view to describe a functional configuration of a display control device;

FIG. 3A is a view to describe a process of displaying options with a hierarchical structure;

FIG. 3B is a view to describe the process of displaying options with the hierarchical structure and illustrates a process subsequent from FIG. 3A;

FIG. 3C is a view to describe the process of displaying options with the hierarchical structure and illustrates a process subsequent from FIG. 3B;

FIG. 4A is a view to describe the process of displaying options with the hierarchical structure and illustrates a process subsequent from FIG. 3C;

FIG. 4B is a view to describe the process of displaying options with the hierarchical structure and illustrates a process subsequent from FIG. 4A; and

FIG. 4C is a view to describe the process of displaying options with the hierarchical structure and illustrates a process subsequent from FIG. 4B.

### DETAILED DESCRIPTION OF EMBODIMENTS

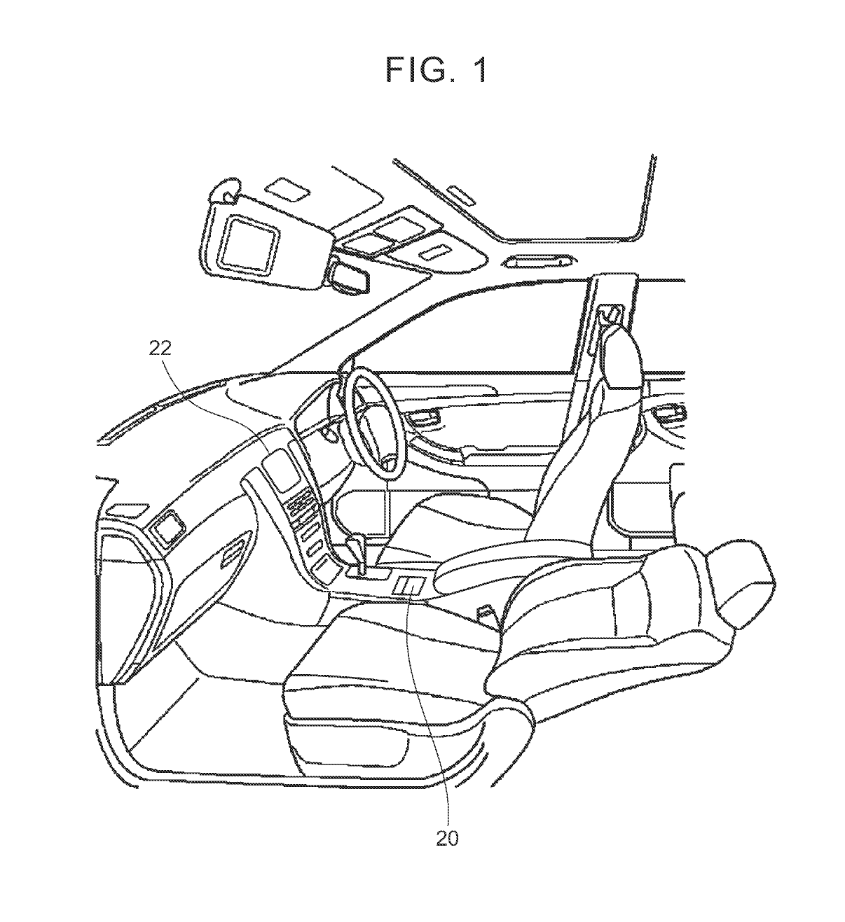

FIG. 1 is a view to describe a touch input portion 20 and a display portion 22 provided in a vehicle. The touch input portion 20 is a touch pad-type input device provided in a center console between a driver seat and a front passenger seat and configured such that a touch operation of a user is input therein. The touch input portion 20 outputs an input signal of the touch operation to a display control device (not shown), so that an image is displayed on the display portion 22 by a control of the display control device.

The display portion 22 is a display. For example, the display portion 22 may be a liquid crystal display. The display portion 22 is provided in a dashboard at a position distanced from the touch input portion 20, and icons corresponding to in-vehicle functions, and the like are displayed thereon. The display portion 22 is provided at a high position ahead of the touch input portion 20 in the vehicle front-rear direction so that a driver can easily look at the display portion 22. While the user is looking at the display portion 22, the user puts a wrist in the center console to input a touch operation, e.g., a slide operation or a tap operation, into the touch input portion 20 without looking at the touch input portion 20, so as to select an in-vehicle function. Note that the touch input portion 20 may be provided with mechanical switches such as a menu button to display a menu image and a back button to return to a previous image.

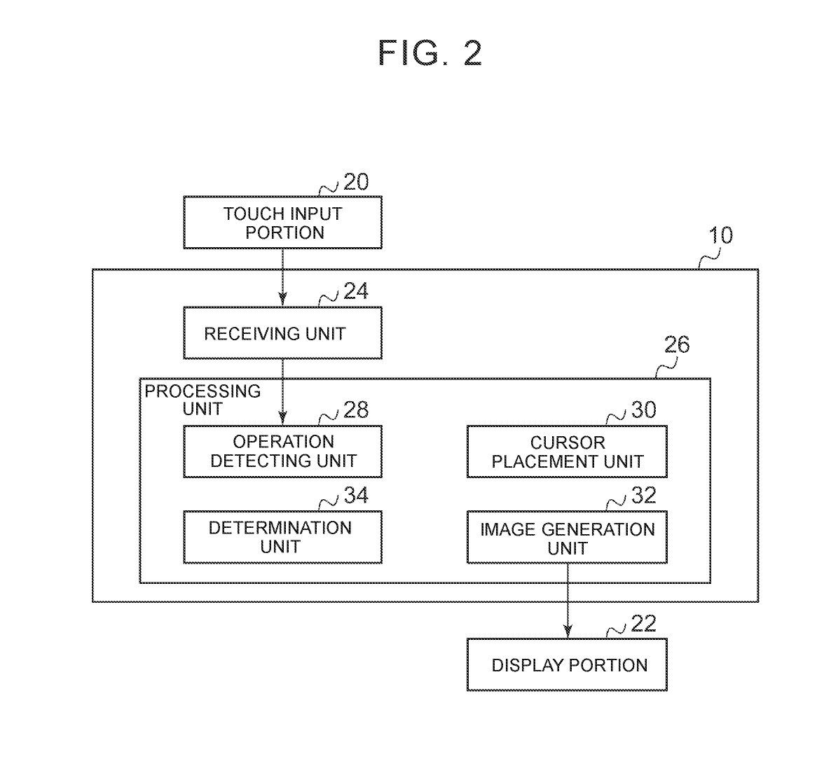

FIG. 2 is a view to describe a functional configuration of a display control device 10. In FIG. 2, each of elements described as functional blocks that perform various processes can be constituted by hardware such as circuitry, more specifically, such as a circuit block, a memory, or other LSI, and can be implemented by software such as a program loaded in a memory. Accordingly, it is understandable for a person skilled in the art that those functional blocks can be implemented in various manners only by hardware, only by software, or by combinations thereof, and they are not limited to any manner.

The display control device 10 includes a receiving unit 24 and a processing unit 26. The receiving unit 24 receives operation information input into the touch input portion 20. The processing unit 26 controls display of the display portion 22 according to the operation information received by the receiving unit 24. The operation information output from the touch input portion 20 includes coordinate information indicative of an input position of a touch operation, and input information of a mechanical switch. The input position on the touch input portion 20 is converted into coordinate information in which the vehicle front-rear direction corresponds to the up-down direction and the vehicle width direction corresponds to the right-left direction with an input initial point being taken as a zero point, for example.

The processing unit 26 includes an operation detecting unit 28, a cursor placement unit 30, an image generation unit 32, and a determination unit 34. The operation detecting unit 28 determines an operation type based on a locus between an input initial point (touch-in) and an input end point (touch-out) indicated by the operation information, and when the operation type is a slide operation, the operation detecting unit 28 detects a slide direction and a slide amount. The operation type includes, for example, a slide operation, a tap operation, a pinch operation, a long push operation, and the like.

The cursor placement unit 30 determines a position of the cursor to be displayed on the display portion 22, that is, a position coordinate of the cursor on a screen, based on the operation information. The cursor placement unit 30 places the cursor so that the cursor moves on the screen of the display portion 22 according to a slide operation to the touch input portion 20. The cursor placement unit 30 may convert a slide operation amount on the touch input portion 20 into a moving amount of the cursor on the display portion 22 by a predetermined aspect ratio. The predetermined aspect ratio for conversion may be set based on the ratio in magnitude between the touch input portion 20 and the display portion 22.

The determination unit 34 determines that a function of an icon is selected according to an input into the touch input portion 20, namely, based on a detection result of the operation detecting unit 28. When a tap operation is performed in a state where the cursor overlaps with an icon, for example, the determination unit 34 determines execution of an in-vehicle function set to the icon, and the image generation unit 32 generates an image of the in-vehicle function thus determined.

The image generation unit 32 generates an image to be displayed on the display portion 22 according to the input into the touch input portion 20, that is, based on a detection result of the operation detecting unit 28, a placement result of the cursor placement unit 30, and a determination result of the determination unit 34. The image generation unit 32 takes out an image corresponding to the in-vehicle function from a memory (not shown) and generates an image by superimposing the cursor on the image thus taken out. The cursor placement unit 30 places the cursor on an image showing options on the display portion 22 without any restriction such that the cursor is movable outside the options, but may place the cursor with restriction so that the cursor does not move outside the options. In a case where the cursor is freely movable on the options without any restriction, if the user loses control of the cursor at the time when the user positions the cursor at an option, the cursor may cause an overshoot across the option.

The image generation unit 32 generates an image to show options with a hierarchical structure. The options with the hierarchical structure are placed in the up-down direction or the right-left direction per hierarchy.

When the receiving unit 24 receives a selection operation in a state where the cursor is placed at one of a plurality of first options in a first hierarchy, the image generation unit 32 displays the first options in the first hierarchy and also displays a plurality of second options in a second hierarchy subsequent thereto, and further, the image generation unit 32 displays the cursor in a state where the cursor is placed at any of the second options. That is, when a tap operation is input in a state where the cursor overlaps with one of the first options in the first hierarchy, the determination unit 34 determines that the first option with which the cursor overlaps is selected. While the image generation unit 32 keeps displaying the first options in the first hierarchy, the image generation unit 32 displays the second options in the second hierarchy subsequent thereto, and further, the image generation unit 32 displays the cursor such that the cursor is automatically moved to a second option in the second hierarchy.

Hereby, when a first option is selected, the cursor is automatically moved to a second option in the subsequent hierarchy. Accordingly, it is possible to reduce an operation for the user to move the cursor from the first option to the second option, thereby making it possible to restrain the cursor from moving outside the second options by the operation. Further, when the driver performs an input operation to the touch input portion 20 in a state where the driver puts the wrist in the center console, the driver cannot easily perform a slide operation in the vehicle width direction because the driver should move the wrist. However, the driver can easily perform a slide operation in the vehicle front-rear direction only by moving a finger. In a case where the first options and the second options are displayed side by side in the right-left direction (the lateral direction), when the cursor is automatically moved from a first option to a second option, it is possible to reduce such a difficult slide operation in the right-left direction.

In a case where the image generation unit 32 displays the cursor in a state where the cursor is automatically moved to a second option from a first option, the image generation unit 32 places the cursor at a second option that is not placed at an end from among the second options displayed in line. Hereby, the user can easily recognize the cursor placed in the middle. Further, other second options are placed to sandwich the cursor therebetween, so that the cursor can be easily moved to other second options in comparison with a case where the operation direction is unidirectional.

More preferably, in a case where the image generation unit 32 displays the cursor in a state where the cursor is automatically moved to a second option from a first option, the image generation unit 32 places the cursor at a second option placed at a second top position from among the second options displayed in line in the up-down direction. Hereby, it is possible to move the cursor to a second option placed at the top by one movement. Further, in the state where the driver puts the wrist in the center console, the driver can more easily perform a slide operation toward the rear side in the vehicle front-rear direction than a slide operation toward the front side in the vehicle front-rear direction. Accordingly, when the number of second options to which the cursor is moved by an operation to the rear side in the vehicle front-rear side direction is increased, a minute operation to the front side in the vehicle front-rear direction can be omitted, so that an input operation can be performed easily.

In a state where the cursor overlaps with any of the second options, when the receiving unit 24 receives an operation to return to the first options, the image generation unit 32 displays the cursor at the first option selected previously. Hereby, the cursor is automatically moved from the second option to the first option selected previously, so that it is possible to reduce an operation for the user to move the cursor from the second option to the first option.

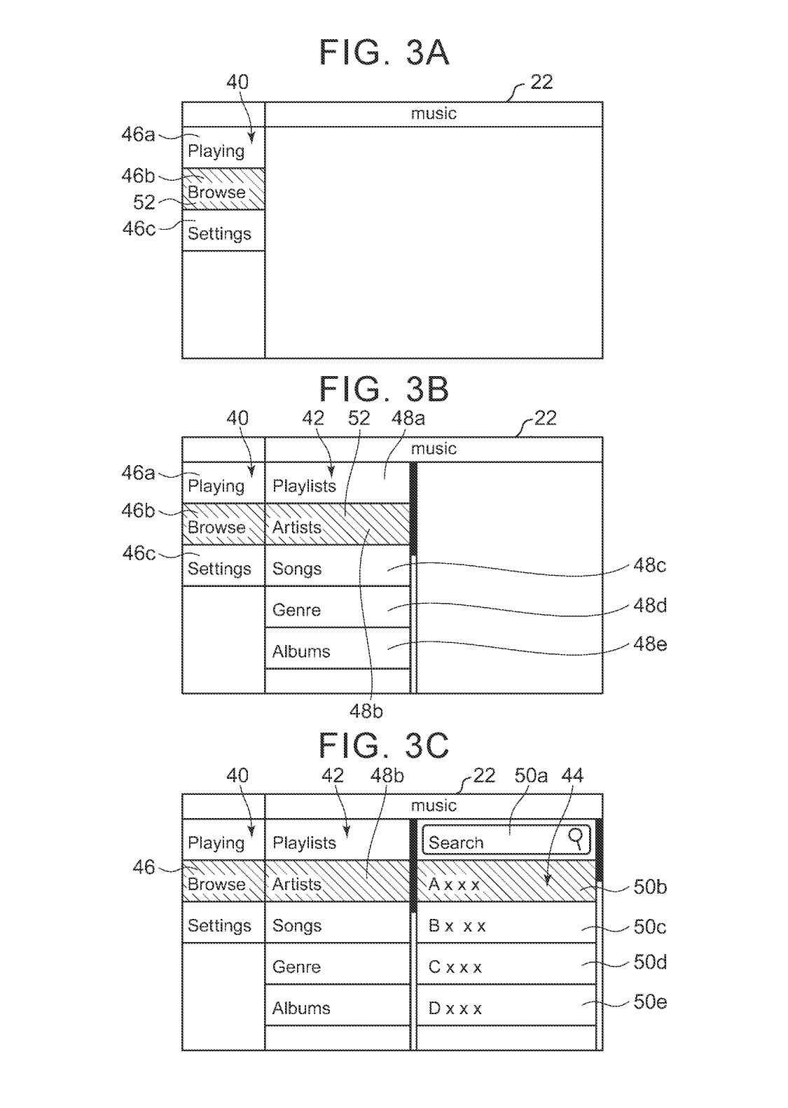

FIGS. 3A to 3C are views to describe a process of displaying options with a hierarchical structure. The present embodiment deals with a display process of options in a music play function, but a function to be dealt with herein is not limited to the music play function, provided that the function has options with a hierarchical structure.

In FIG. 3A, a plurality of first options 46a, 46b, 46c (when they are not distinguished from each other, they are just referred to as “first options 46”) in a first hierarchy 40 are displayed in the left end on the display portion 22 such that they are placed in line in the up-down direction (the vertical direction). A cursor 52 is placed at a first option 46b that is the second from the top, and the first option 46b where the cursor 52 is placed at least partially has a pixel value different from the other first options 46a, 46c, so that the first option 46b is displayed with a higher or lower luminance than the first options 46a, 46c, for example.

When a user performs a tap operation in the state where the cursor 52 is placed at the first option 46b, the first option 46b is selected, so that a plurality of second options 48a, 48b, 48c, 48d, 48e (when they are not distinguished from each other, they are just referred to as “second options 48”) in a second hierarchy 42 as illustrated in FIG. 3B are displayed.

When the operation detecting unit 28 detects a tap operation in the state where the cursor 52 is placed at the first option 46b, the determination unit 34 determines to display the second options 48 in the second hierarchy 42, and the cursor placement unit 30 automatically places the cursor 52 at one of the second options 48 in the second hierarchy 42. The image generation unit 32 reads out an image to display the second options 48 in the second hierarchy 42 based on a determination result of the determination unit 34 and generates an image in which the cursor 52 is placed on the second option 48 based on a placement result of the cursor placement unit 30. Thus, the image generation unit 32 automatically moves the cursor 52 placed at the first option 46b to the second option 48b that is the second from the top, and hereby, it is possible to reduce an operation for the user to move the cursor 52 to any of the second options 48.

The second options 48 in the second hierarchy 42 are placed in line on the right side from the first options 46 in the first hierarchy 40, such that the second options 48 are placed in line in the up-down direction. When the second options 48 in the second hierarchy 42 are displayed, the selected first option 46b is displayed with a pixel value different from the other first options 46a, 46c, for example, such that the selected first option 46b is displayed with a higher or lower luminance than the other first options 46a, 46c. Hereby, the first option 46 selected previously can be shown to the user. An option selected previously is stored in the cursor placement unit 30.

When the operation detecting unit 28 detects a tap operation in the state where the cursor 52 is placed at the second option 48b as illustrated in FIG. 3B, the determination unit 34 determines to display a plurality of third options 50a, 50b, 50c, 50d, 50e (when they are not distinguished from each other, they are just referred to as “third options 50”) in a third hierarchy 44. The cursor placement unit 30 automatically places the cursor 52 at one of the third options 50 in the third hierarchy 44. Then, as illustrated in FIG. 3C, the image generation unit 32 reads out an image to display the third options 50 in the third hierarchy 44 based on a determination result of the determination unit 34 and generates and displays an image in which the cursor 52 is placed on the third option 50b based on a placement result of the cursor placement unit 30.

In FIG. 3C, the image generation unit 32 automatically moves the cursor 52 placed at the second option 48b to the third option 50b that is the second from the top, and hereby, it is possible to reduce an operation for the user to move the cursor 52 to any of the third options 50. The third option 50a at the top in the third hierarchy 44 shows a field for searching a third option 50.

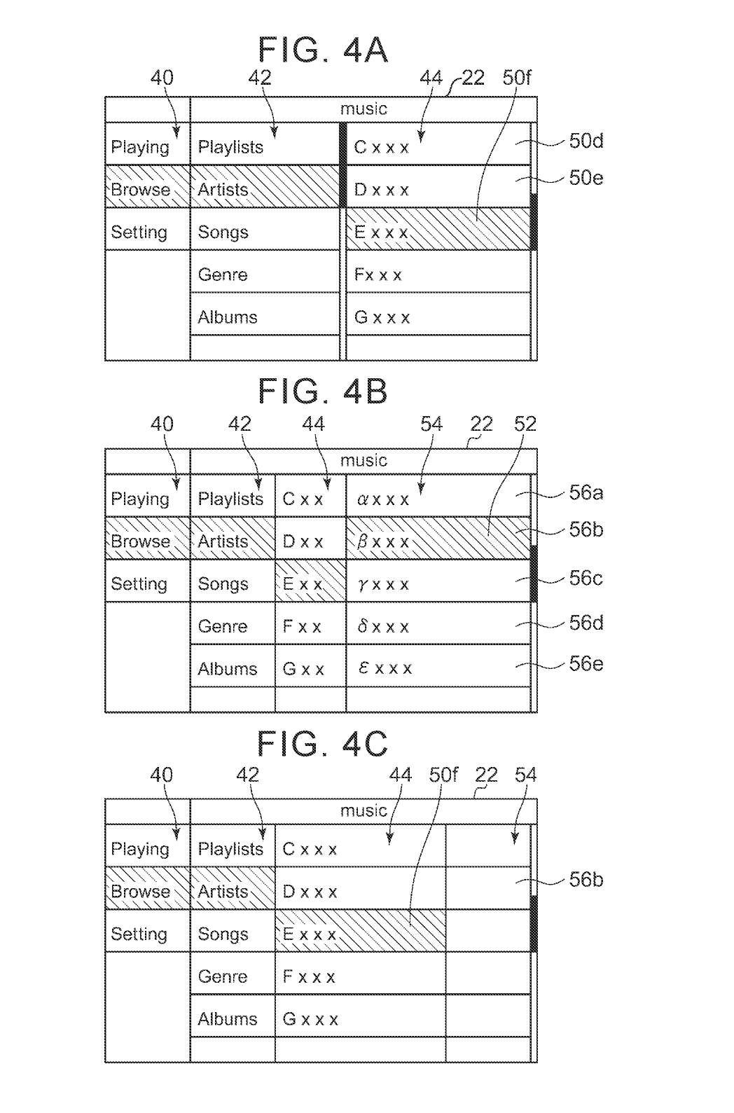

FIGS. 4A to 4C are views to describe the process of displaying options with the hierarchical structure and illustrates a process subsequent from FIG. 3C. FIG. 4A illustrates a state where, in the state where the third options 50 in the third hierarchy 44 are displayed, the user performs a slide operation to the rear side in the vehicle front-rear direction so as to move the cursor 52 downward to the third option 50f.

When the user performs a tap operation in the state where the cursor 52 is placed at the third option 50f, fourth options 56a, 56b, 56c, 56d, 56e (when they are not distinguished from each other, they are just referred to as “fourth options 56”) in a fourth hierarchy 54 are displayed, as illustrated in FIG. 4B.

The cursor placement unit 30 moves the cursor 52 placed at the third option 50f to the fourth option 56b that is the second from the top among the fourth options 56 displayed in line. Although the second options 48 in the second hierarchy 42 and the third options 50 in the third hierarchy 44 are maintained to be displayed, the third options 50 are displaced to the first hierarchy 40 side, so that the second options 48 and the third options 50 are displayed with reduced widths. Hereby, while the options in the hierarchies selected previously and the options in the hierarchy selected newly are displayed together within the width of the display portion 22, a display width for the options in the hierarchy newly selected can be secured.

When the user performs an operation to return to a previous hierarchy, e.g., the user performs a slide operation to the left side or presses a back button, in the state where the cursor 52 is placed at any of the fourth options 56, the image generation unit 32 displays the third options 50 on the top surface and displays the cursor 52 in a state where the cursor 52 is placed at the third option 50f selected previously, as illustrated in FIG. 4C. That is, in the state where the cursor 52 overlaps with any of the fourth options 56, when the receiving unit 24 receives an operation to return to the third options 50, the image generation unit 32 displays the cursor 52 at the third option 50f selected previously. Hereby, it is possible to restart the operation from the state selected previously.

Note that the embodiment is just an example, and it is understandable for a person skilled in the art that various modifications can be employed for combinations of the constituents and such modifications are also within the scope of the disclosure.

What is claimed is:

1. A display control device comprising:
a receiving unit configured to receive operation information input into a touch input portion placed at a position distanced from a display portion; and
a processing unit configured to control display of the display portion according to the operation information received by the receiving unit, wherein
the processing unit is configured to display a plurality of first options belonging to a first hierarchy, a plurality of second options belonging to a second hierarchy as a hierarchy subsequent to the first hierarchy, and a cursor placed at one of the plurality of second options on the display portion when the receiving unit receives a selection operation in a state where the cursor is placed at one of the plurality of first options.

2. The display control device according to claim 1, wherein
the processing unit is configured to place the cursor at a second option that is not placed in an end on the display portion, from among the plurality of second options displayed in line on the display portion, when the display of the display portion is changed from a state where the cursor is placed at the one of the plurality of first options to a state where the cursor is placed at the one of the plurality of second options.

3. The display control device according to claim 1, wherein
the processing unit is configured to display the cursor at a previously selected first option when the receiving unit receives an operation to return to the first hierarchy in a state where the cursor is placed at any one of the plurality of second options.

4. The display control device according to claim 2, wherein
the processing unit is configured to place the cursor at a second option placed at a second top position on the display portion, from among the plurality of second options displayed in line on the display portion, when the display of the display portion is changed from the state where the cursor is placed at the one of the plurality of first options to the state where the cursor is placed at any of the plurality of second options.

5. The display control device according to claim 1, wherein
the processing unit is configured to display the plurality of second options and a plurality of third options belonging to a third hierarchy as a hierarchy subsequent to the second hierarchy, and the cursor placed at one of the plurality of third options on the display portion when the receiving unit receives a selection operation in a state where the cursor is placed at one of the plurality of second options.

6. The display control device according to claim 5, wherein:
the processing unit is configured to display, on the display portion, the plurality of third options and a plurality of fourth options belonging to a fourth hierarchy as a hierarchy subsequent to the third hierarchy, and the cursor placed at one of the plurality of fourth options in a state where the plurality of third options is displayed with a reduced width as compared to a width of the plurality of third options before the plurality of fourth options are displayed when the receiving unit receives a selection operation in a state where the cursor is placed at one of the plurality of third options.

7. The display control device according to claim 1, wherein
the processing unit is configured to display a first option selected from among the plurality of the first options with a pixel value different from the other first options, while the plurality of second options are displayed on the display portion.
